(19) United States
(12) Patent Application Publication
(10) Pub. No.: US 2025/0135929 A1
(43) Pub. Date: May 1, 2025

(54) IMPROVED RECHARGE SYSTEM FOR VEHICULAR BATTERIES AND RELATED RECHARGE METHOD

(71) Applicant: IVECO FRANCE S.A.S., Venissieux (FR)

(72) Inventor: Stephane Codron, Venissieux (FR)

(73) Assignee: IVECO FRANCE S.A.S., Venissieux (FR)

(21) Appl. No.: 18/683,319

(22) PCT Filed: Aug. 29, 2022
(86) PCT No.: PCT/IB2022/000482

§ 371 Date: Feb. 13, 2024

(30) Foreign Application Priority Data
Aug. 30, 2021 (IT) 102021000022544

(51) Int. Cl. B60L 53/302; B60L 53/31; B60L 53/35; B60L 58/26

(52) U.S. Cl. CPC B60L 53/302; B60L 53/31; B60L 53/35; B60L 58/26; B60L 2200/18; B60L 2240/545

(57) ABSTRACT

A vehicle with an at least partially electric drive and comprising at least one electric battery module, electrical connection means configured to be electrically connected to the battery module, thus allowing it to be charged thanks to electric recharging means, a conditioning system configured to adjust the temperature of the battery module,
the vehicle comprising fluidic connection means configured to fluidly connect the conditioning system to a recharging cooling circuit external to the vehicle configured to cool the battery module through the conditioning system of the vehicle.

### CROSS-REFERENCE TO RELATED APPLICATIONS

This Patent Application claims priority from Italian Patent Application No. 102021000022544 filed on Aug. 30, 2021, the entire disclosure of which is incorporated herein by reference.

### TECHNICAL FIELD

The invention relates to a recharging system for an at least partially electric drive vehicle.

The invention has its preferred, though non-exclusive application in a recharging station for a vehicle for collective passenger transportation. Hereinafter, reference will be made to this application by mere way of example.

### PRIOR ART

In electric drive vehicles, electric batteries must be kept at a constant temperature, preferably around 25°, in order to ensure a high efficiency thereof and avoid heat-related problems, such as thermal instability.

To this purpose, a battery conditioning system is usually provided, which is configured to heat the batteries in winter and, especially, cool them in summer.

This conditioning system generally comprises a fluid heat exchanger configured to dissipate the heat contained in fluid flowing close to the batteries.

The sizing of the conditioning system is chosen taking into account the battery recharging phase. Indeed, in order to ensure a reasonable recharging time, batteries are charged in high voltage and need to dissipate a large quantity of heat. Hence, the conditioning system is activated when the batteries are charged so as to dissipate said heat and avoid dangerous situations of thermal instability.

The use of the conditioning system during the charge of the vehicle is scarcely effective, unless it is oversized.

The oversizing of the conditioning system increases manufacturing costs and reduces the space than can be used on the vehicle.

In order to avoid excessively oversizing the conditioning system, the maximum electric current for the charge of the batteries is limited. This limitation leads to a consequent increase in the vehicle charging time.

Therefore, known electric battery conditioning systems need to be improved in order to reduce battery charging times and decrease the space taken up as well as costs.

The invention is aimed at solving the above-mentioned drawbacks in an optimized and economic fashion.

### SUMMARY OF THE INVENTION

The above-mentioned objects are reached by means of a recharging station and by means of a vehicle comprising a system according to the appended claims and a related recharging method.

### BRIEF DESCRIPTION OF THE DRAWINGS

Further features and advantages of the invention will be best understood upon perusal of the description below, which is provided by mere way of explanatory and non-limiting example, with reference to the accompanying drawings, wherein:

FIG. 1 is a perspective view of a vehicle recharging station comprising a conditioning system according to the invention;

FIG. 2 is a schematic view from the top of the station and of the vehicle of FIG. 1;

FIGS. 3 and 4 are schematic views from the top of the recharging station and of the vehicle according to the invention in two operating conditions.

### DETAILED DESCRIPTION OF THE INVENTION

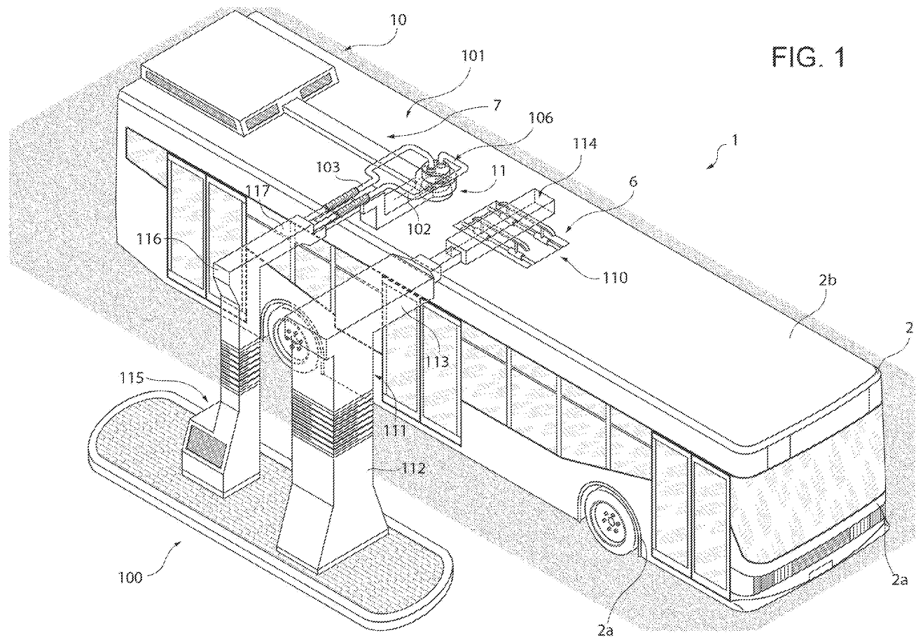

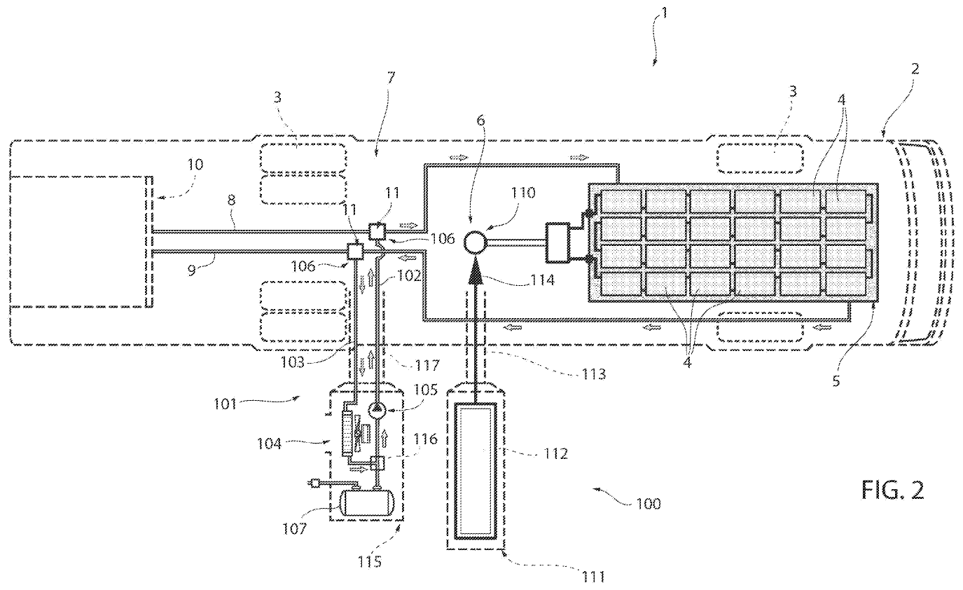

FIGS. 1 and 2 show a vehicle 1 for collective passenger transportation comprising a plurality of walls 2, namely a pair of side walls 2a, a roof 2b and a floor (nor visible), which are joined to one another so as to define an inner volume, which can accommodate the passengers of the vehicle 1.

The vehicle 1 moves on the ground thanks to a powertrain (not shown), which is configured to provide a plurality of wheels 3 with a torque. The vehicle 1 comprises a plurality of battery modules 4 configured to store power to be used by the powertrain in order to provide the wheels 3 with a torque. As a consequence, the vehicle 1 is an at least partially electric drive vehicle.

In the embodiment described herein, the plurality of battery modules 4 are housed on the roof 2b, preferably inside a common housing 5.

The vehicle 1, as it is known, comprises electrical connection means 6 configured to allow the battery modules 4 to be charged in a recharging station 100. Said electrical connection means 6 can be pads, connectors or magnetic induction plates configured to permit the transmission of a high voltage/high intensity to charge the battery modules 4.

Furthermore, as it is known, the vehicle 1 comprises a fluid conditioning system 7 to adjust the temperature of the battery modules 4.

As shown in the accompanying figures, the conditioning system 7 advantageously comprises a delivery duct 8 configured to deliver a fluid at at first temperature to the battery modules 4 and a return duct 9 configured to receive fluid at a second temperature from the battery modules 4.

The conditioning system 7 further comprises a heat exchanger 10 configured to allow heat to be exchanged with the fluid flowing in the return duct 9 before it flows into the delivery duct 8.

Depending on operating conditions and environment, the heat exchanger 10 can facilitate the release of heat from the fluid in the return duct 9 to the delivery duct 8, for example by means of ventilation means, or can facilitate the increase of heat in the fluid in the return duct 9 towards the delivery duct 8, for example thanks to Joule-effect means or infrared radiators.

The delivery duct 8 and the return duct 9 are configured to be fitted into the housing 5 so as to directly reach the battery modules 4 or be connected to heat exchange ducts, as known in the state of the art.

According to the invention, the vehicle 1 is provided with fluidic connection means 11 fluidly interposed along each one of said delivery duct 8 and return duct 9 so as to allow the delivery duct 8 and the return duct 9 to be connected to a recharging cooling circuit 101, which is part of the aforesaid recharging station 100.

The fluidic connection means 11 can comprise valve means configured to permit a fluid communication among the delivery and return ducts 9, the recharging cooling circuit 101 and the battery modules 4. If necessary, the fluidic connection means 11 can also allow for the connection, in addition to the preceding elements, of the conditioning system 7.

The recharging cooling circuit 101 basically comprises a delivery conduit 102 configured to deliver low-temperature fluid and a return conduit 103 configured to receive high-temperature fluid. Between the return conduit 103 and the delivery conduit 102 there is interposed a heat exchanger 104 configured to dissipate the heat of the fluid flowing in the return conduit 103 towards the outside. The recharging cooling circuit 101 can comprise ventilation means configured to provide an air flow flowing through the heat exchanger 104 in order to facilitate the exchange of heat with the surroundings.

The recharging cooling circuit 101 can advantageously comprise pumping means 105, which are preferably located downstream of the heat exchanger 104 and are configured to allow the fluid to flow between the delivery conduit 102 and the return conduit 103.

The delivery conduit 102 and the return conduit 103 are fluidly connected to fluidic connection means 106 configured to cooperate with the fluidic communication means 11 obtained on the vehicle 1, so as to fluidly connect the delivery conduit 102 to the delivery duct 8 and the return conduit 103 to the return duct 9.

The recharging cooling circuit 101 can also advantageously comprise a reservoir 107 configured to provide a sufficient supply of fluid, if necessary, and to allow the recharging cooling circuit 101 to be filled. As already mentioned above, the recharging cooling circuit 101 is part of the recharging station 100.

The latter comprises an electric recharging means 110 advantageously carried, in a movable manner, by a robotic arm 111. Said robotic arm 111 comprises a column 112 and at least one articulated arm 113 configured to carry, at the end, electric recharging means 114, which are configured to electrically cooperate with the electric connection means 6. An example of this structure, by mere way of example, is shown in EP3552866A1.

The recharging cooling circuit 101 can be housed in the column 112 of the electric recharging means 110 or, as shown herein, carried by a robotic arm 115 comprising a column 116 and an articulated arm 117 distinct from the ones of the recharging means 110.

The robotic arms 111, 115 are configured to move the hydraulic connection means 106 and the electric recharging means 114 with at least three degrees of freedom of movement.

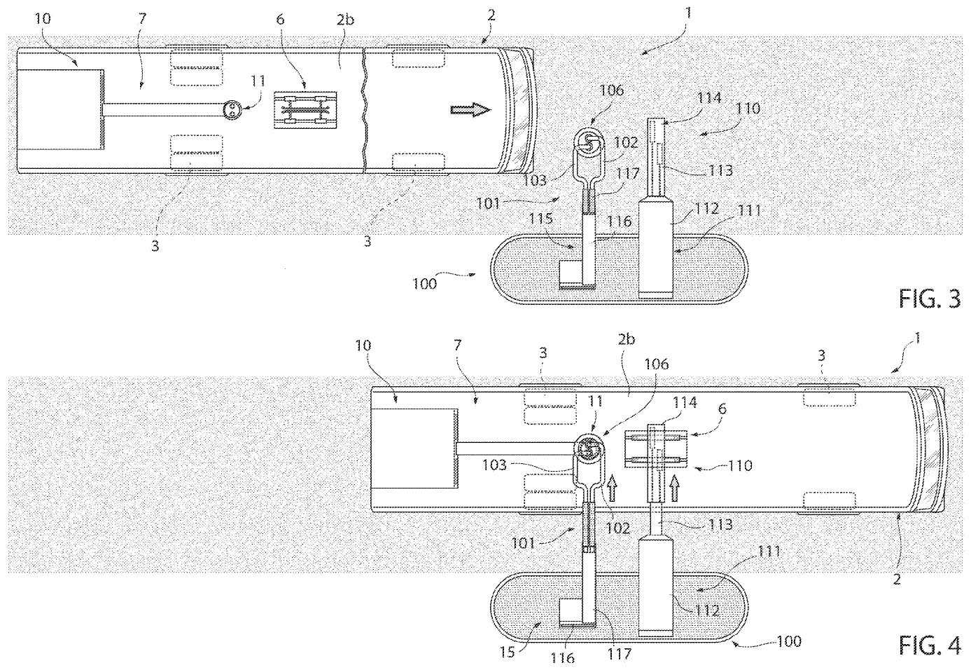

The operation of the recharging system described above will be described below with reference to FIGS. 3 and 4.

The vehicle 1 approaching the recharging station 100 is located in a position such that the electric recharging means 110 and the recharging cooling circuit 101 can be connected to the electrical connection means 6 and to the water connection means 11, respectively.

Thanks to known control means, the robotic arms 111, 115 are controlled so as to connect the electric recharging means 110 and the recharging cooling circuit 101 to the electrical connection means 6 and to the fluidic connection means 11.

Once the aforesaid elements are connected to one another, the electric recharging means 110 start charging the battery modules 4. At the same time, the recharging cooling circuit 101 is activated in parallel, so as to cause the cooled conditioning fluid to flow between the battery modules 4 in order keep their temperature low and allow for a charge at a high current intensity.

Owing to the above, it is evident that the invention relates to a recharging method for an at least partially electric drive vehicle comprising the following steps:
i) electrically connecting the battery modules of the vehicle to an electric recharging system;
ii) fluidly connecting a battery module conditioning system to a recharging cooling circuit;
iii) once the operations of steps i) and ii) have been completed, recharging the battery modules and, in parallel, causing a cooling fluid to circulate through the recharging cooling circuit.

The method described above also comprises the steps of:
iv) when the batteries are charged, interrupting step iii);
v) electrically disconnecting the vehicle battery modules from the electric recharging system;
vi) fluidly disconnecting the conditioning system for the battery modules from the recharging cooling circuit.

In particular, steps i) and ii) each comprise:
i′) detecting the position of vehicle 1 in relation to the recharging station;
i″) controlling, depending on the position detected in point i′), a robotic arm so as to connect the battery modules of the vehicle to the electric recharging system;
i′″) controlling, depending on the position detected in point i′), a robotic arm so as to connect the conditioning system of the battery modules to the recharging cooling circuit.

The recharging station further comprises an electronic control unit, which is not shown herein, is configured to be electrically connected to the actuators and to the operating elements of the recharging station 100 and comprises processing means designed to control the operations thereof.

The electronic control unit is configured to control the aforesaid elements of the robotic arms 111, 115, the electric recharging means 110 and the recharging cooling circuit 101 in an automatic manner following the suggested process developed in a specific software code, which can be downloaded onto the electronic unit and is configured to carry out the recharging method described above.

As already mentioned above, the process can be carried out by the control unit through a computer program. Said computer program comprises instruction, which cause the control unit to carry out the process when the program is executed by the control unit. The computer program can be stored in a device that can be read by a computer.

Owing to the above, the advantages of a system, a vehicle and a method according to the invention are absolutely evident.

Thanks to the system disclosed herein, the batteries of the vehicle can significantly be cooled, allowing them to be charged with a higher current intensity compared to the normal one, thus reducing charging times to a time that is deemed acceptable by users (less than 5 minutes).

Indeed, the recharging hydraulic circuit can be sized so as to dissipate a large quantity of heat from the fluid flowing in the cooling circuit towards the outside, thus permitting a charge at a very high voltage/current intensity.

Thanks to the use of the recharging hydraulic circuit separate from the vehicle, the conditioning circuit of the vehicle can exclusively be sized for the standard operation thereof, hence reducing the occupied space, its weight and its cost.

Furthermore, thanks to the fact that the recharging cooling circuit is external, the charge of the batteries is more effective: higher current and shorter time.

Finally, the system, the vehicle and the method according to the invention can clearly be subjected to changes and variants, which, though, do not go beyond the scope of protection set forth in the claims.

For example, a recharging station could comprise one single column with a pair of articulated arms containing the recharging hydraulic circuit and the electric recharging means.

It is evident that the hydraulic type and the elements included in the recharging cooling circuit could change depending on the needs of the vehicle.

1. Vehicle (1) with at least partially electric traction and comprising at least one electric battery module (4),
said vehicle comprising electrical connection means (6) configured to be electrically connected to said at least one battery module (4) to allow its recharging by means of electric recharging means (110)
said vehicle comprising a conditioning system (7) configured to regulate the temperature of said at least one battery module (4),
said vehicle (1) comprising fluidic connection means (11) configured to fluidly connect said conditioning system (7) to a recharging cooling circuit external to the vehicle (101) configured to cool said at least one battery module (4) through said conditioning system (7) of said vehicle (1)
wherein said conditioning system (7) comprises a delivery duct (8) and a return duct (9) configured to allow a conditioning fluid to circulate in the vicinity of said at least one battery module (4), said fluidic connection means (11) comprising valve means fluidly interposed on said discharge conduit (8) and on said return conduit (9) and configured to connect a discharge conduit (112) and a return duct (113) of said recharge cooling circuit (101).

2. Vehicle according to claim 1, wherein said vehicle (1) comprises a plurality of side walls (2a) a roof (2b) and a floor defining a space for carrying passengers, said at least one battery module (4), said electrical connection means (6) and said fluidic connection means (11) being carried by said roof (2b).

3. Recharging station (100) for a vehicle (1) according to claims claim 1, said recharging station (100) comprising a charging cooling circuit (101) and electric charging means (110), said recharging cooling circuit (101) comprising hydraulic connection means (106) configured to fluidly connect to said fluid communication means (11) of said vehicle (1) and electrical recharging means (114) configured to electrically cooperate with said electrical connection means (6).

4. Recharging station according to claim 3, wherein said recharging cooling circuit (101) and the electrical recharging means (110) are carried by at least one robotic arm (111, 115) configured to move said means of hydraulic connection (106) and said electrical recharging means (114) on at least three degrees of freedom of movement.

5. Recharging station according to claim 4, wherein said robotic arm comprises a column (112, 116) and an articulated arm (113, 117) movably carried relative to said column (112, 116).

6. Recharging station according to claim 4, wherein said charging cooling circuit (101) is carried by a first robotic arm (111) and said electrical recharging means (110) are carried by a second robotic arm (115) distinct from said first robotic arm (111).

7. Recharging station according to claim 3, wherein said recharging cooling circuit (101) comprises a delivery duct (112) and a return duct (113) each provided with said fluid connection means (106), said recharge cooling circuit (101) comprising a heat exchanger (104) configured to dissipate heat from the conditioning fluid flowing through said conduits (112, 113) to the environment.

8. Recharging station according to claim 7, wherein said recharging cooling circuit (101) comprises pumping means (105) configured to allow the circulation of said fluid in said conduits (112, 113).

9. Recharging station according to claim 7, wherein said recharging cooling circuit (101) comprises ventilation means configured to provide an air flow through said heat exchanger (104).

10. Recharging station according to claim 7, wherein said recharging cooling circuit (101) comprises a reservoir (107) fluidly connected to said conduits (112, 113).

11. A system comprising a recharging station (100) according to claim and a vehicle (1) with at least partially electric traction and comprising:
at least one electric battery module (4),
said vehicle comprising electrical connection means (6) configured to be electrically connected to said at least one battery module (4) to allow its recharging by means of electric recharging means (110)
said vehicle comprising a conditioning system (7) configured to regulate the temperature of said at least one battery module (4),
said vehicle (1) comprising fluidic connection means (11) configured to fluidly connect said conditioning system (7) to a recharging cooling circuit external to the vehicle (101) configured to cool said at least one battery module (4) through said conditioning system (7) of said vehicle (1)
wherein said conditioning system (7) comprises a delivery duct (8) and a return duct (9) configured to allow a conditioning fluid to circulate in the vicinity of said at least one battery module (4), said fluidic connection means (11) comprising valve means fluidly interposed on said discharge conduit (8) and on said return conduit (9) and configured to connect a discharge conduit (112) and a return duct (113) of said recharge cooling circuit (101).

12. Method of recharging the battery modules of an at least partially electric traction vehicle, said method comprising the following phases:
i) electrically connect the vehicle's battery modules to an electrical recharging system;
ii) fluidly connecting a battery module conditioning system to a recharge cooling circuit;
iii) once the operations of phases i) and ii) have been completed, recharge the battery modules and, in parallel, circulate a cooling fluid through said recharging cooling circuit.

13. A recharging method according to claim 12, also comprising the phases of:
iv) when the batteries are charged, interrupt phase iii);
v) electrically disconnect the vehicle battery modules from the electrical charging system;
vi) fluidly disconnect the conditioning system for the battery modules from the recharge cooling circuit.

14. Recharging method according to claim 12, wherein phases i) and ii) each comprise:
i′) detecting the position of vehicle 1 in relation to the charging station;
i″) control, depending on the position detected in point i″) a robotic arm to connect the vehicle's battery modules to the electrical charging system;
i′″) control, depending on the position detected in point i′) a robotic arm to connect the conditioning system of the battery modules to the recharging cooling circuit.
